(19) United States
(12) Patent Application Publication
(10) Pub. No.: US 2006/0070831 A1
(43) Pub. Date: Apr. 6, 2006

(54) Carbon-ceramic brake disc

(75) Inventors: Harald Reulein, Megesheim (DE); Peter Winkelmann, Thierhaupten (DE); Florian Zapf, Gersthofen (DE)

Correspondence Address: CONNOLLY BOVE LODGE & HUTZ, LLP, P O BOX 2207, WILMINGTON, DE, 19899, US

(73) Assignee: SGL CARBON AG, Wiesbaden (DE)

(21) Appl. No.: 11/237,243

(22) Filed: Sep. 28, 2005

(30) Foreign Application Priority Data
Oct. 5, 2004 (EP) 04023664.8

(51) Int. Cl. F16D 65/12

(52) U.S. Cl. 188/218 XL

(57) ABSTRACT

A carbon-ceramic brake disc which can be secured directly to the wheel axle without a metal hub plate, the brake disc being made from ceramic reinforced with carbon fibres and having the shape of a hub plate in the vicinity of the axis of rotation and the shape of an annular disc in the vicinity of the outer periphery

### FIELD OF THE INVENTION

The invention relates to a carbon-ceramic brake disc which can be secured directly to the wheel axle without a hub plate.

### BACKGROUND OF THE INVENTION

Carbon-ceramic brake discs are known from the patent literature. For example, patent application DE 44 38 456 A1 describes friction elements which take the form of a cylindrical ring, there being bores made along the inner periphery which make it possible to secure the friction disc to the wheel axle. In this case, the ratio between the internal diameter and the external diameter of the friction disc is approximately 40% (FIG. 1A of the drawing).

A brake disc which is ventilated from the inside and made from a carbon-ceramic material is also known from the application DE 195 43 799 A1, which comprises two parallel discs connected to one another by pins. The two discs are also in the form of a cylindrical ring and the internal diameter, in accordance with FIG. 2 of the drawing, is approximately 33% of the external diameter.

In the patent DE 197 21 647, too, cylindrical ring discs made from carbon-ceramic are disclosed in which the ratio between the internal and the external diameter is approximately 48% in FIG. 13.

In the patent DE 197 19 634 C1, a brake unit is disclosed which includes a ceramic brake disc with a metal hub plate. The hub plate and the brake disc are bolted to one another, the receivers for the bolts being lined with a sleeve of plastically deformable material, or the brake disc being itself plastically deformable in the region of the bolts. This approach is intended to obviate the problems caused by the differing thermal expansion of the different materials. Here too, in FIG. 6a, the internal diameter of the brake disc is approximately 33% of the external diameter, and different materials are used for the brake disc and the hub plate. Thus, although the problem of different materials is addressed in DE 197 19 634 C1, it is solved by a particular form of fixing.

It has not hitherto been known from the prior art that the problem of differing thermal expansion between the hub plate and the brake disc ring can be solved by avoiding the use of a hub plate completely. A metal hub plate has been regarded as indispensable, in particular because there is no need for particular care to be taken when mounting the brake disc, composed of the hub plate and the friction ring, on the shaft, since a connection is only being made here between two metal parts. Securing the hub plate to the friction ring was much more critical an operation, with the additional problem of differing thermal expansion. Furthermore, the metal hub plate bit only carries the friction ring but is also used to secure the wheels and so has to have two planes which are offset from one another in the direction of the axis of rotation. The friction ring is conventionally mounted on the side remote from the wheel (in the case of a carbon-ceramic brake disc) or itself forms the friction ring (in the case of a cast iron brake disc). The offset between the two planes must be sufficiently large to allow the wheels to be mounted, so that a sufficient clearance is maintained between the wheels and the brake disc which becomes hot during operation.

As an alternative to the solution of using a single hub plate with offset planes, two flanges may be mounted on the shaft, of which the inner carries the friction disc and the outer carries the wheel. However, for the purpose of installation and removal, the friction disc, which is in the shape of a cylindrical ring, would then have to have an internal diameter which is at least as large as the external diameter of the flange carrying the wheel when it is on the shaft. In this case, forces would be transmitted from the wheel to the friction disc and vice versa by way of the shaft, and would subject the latter to a considerable torsional stress, since the forces increase as proximity to the axis of rotation increases. Consequently, this does not provide a technically satisfactory solution.

### SUMMARY OF THE INVENTION

In accordance with the present invention, this problem is solved in that the friction ring and the hub plate are made in one piece from a ceramic material.

The invention thus relates to a carbon-ceramic brake disc which is secured directly to the wheel axle without a hub plate, the brake disc being made from ceramic reinforced with carbon fibres and having the shape of a hub plate in the vicinity of the axis of rotation and the shape of an annular disc in the vicinity of the outer periphery. Here, the internal diameter is determined solely by the dimensions of the securing flange on the wheel axle. In the vicinity of the internal diameter there are provided securing means which cooperate with corresponding securing means on the wheel axle and so provide a connection.

Advantageously, at least three bores or recesses are arranged around the inner periphery, corresponding to similar bores or recesses, such as threads, or mounted pins on the wheel axle. When the brake disc is assembled, care must be taken to ensure that when the securing means are secured approximately the same pressure is applied to the ceramic material at each securing point.

With this type of assembly, there is an advantage over the conventional embodiment having a metal hub plate, in that the forces are introduced into the friction ring, and hence also into the reinforcing structure, over a shorter distance and more uniformly. Local peaks in stress are thus reduced by comparison with the conventional configuration. It has been shown that, surprisingly, this positive effect more than compensates for the possible disadvantage of the higher forces caused by the shorter lever arm. The smaller number of securing means for the brake disc which are required here constitutes a further advantage.

### DETAILED DESCRIPTION OF THE PREFERRED EMBODIMENTS

The dimensions of the brake disc according to the invention are preferably such that the internal diameter is approximately 40 mm to approximately 100 mm, preferably from 40 mm to 100 mm, and the disc body is divided up so that the inner face close to the axis of rotation extends perpendicular to the axis of rotation in the radial direction starting at 10% to 25% of the way along the radius and ending at 20% to 45%; then there follows a cranked part starting at 20% to 35% and ending at 25% to 70% of the way along the radius. This is then adjoined by the friction ring part, which extends adjoining the latter, from 25% to 70% of the way along the radius to 100% of the way along the radius.

### DESCRIPTION OF THE DRAWINGS

In the drawing,

FIG. 1 shows a section through a brake disc according to the invention, in which the dimensions discussed in the previous paragraph are illustrated.

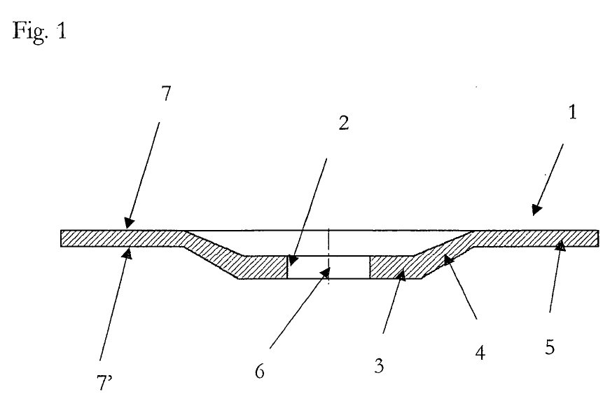

Here, in FIG. 1, on the brake disc 1 the inner periphery which delimits the flat inner disc part 3 perpendicular to the axis of rotation 6 is designated as 2. Adjoining this, there follows the cranked part 4, which merges into the friction ring 5. The amount by which the opening extends in the radial direction towards the inner periphery 2 is 30 mm to 50 mm as measured from the axis of rotation 6, and the inner flat disc part 3 extends from 10% to 45% of the way along the radius, the cranked part 4 extends from 20% to 70% of the way along the radius, and then the friction ring 5, whereof the relatively large faces 7 and 7′ are again perpendicular to the axis of rotation 6, extends from 25% to 70% to 100% of the way along the radius.

The advantage of the configuration according to the invention stems not only from the fact that stresses produced by the differing thermal expansion coefficients, as already explained, are avoided, but also from the more favourable conditions for the introduction of forces from the friction ring part to the hub part.

It is preferable to make the brake discs according to the invention from a ceramic reinforced with carbon fibres whereof the matrix substantially comprises silicon carbide, silicon and carbon.

Here, it is particularly preferable if carbon fibres having an average length of more than 30 mm, particularly preferably at least 50 mm, are used in the zone having the shape of a hub plate, that is to say the regions of the face 3 and the cranked part 4.

1. A carbon-ceramic brake disc (1) which can be secured directly to the wheel axle without a metal hub plate, the brake disc being made from ceramic reinforced with carbon fibres and having the shape of a hub plate in the vicinity of the axis of rotation (6) and the shape of an annular disc in the vicinity of the outer periphery.

2. The carbon-ceramic brake disc (1) according to claim 1, characterised in that at least three bores or recesses are arranged around the inner periphery (2), corresponding to similar bores or recesses or mounted pins on the wheel axle.

3. The carbon-ceramic brake disc (1) according to claim 1, characterised in that the internal diameter is 40 mm to 100 mm, and in that the disc body is divided up so that the inner flat disc part (3) close to the axis of rotation extends perpendicular to the axis of rotation (6) in the radial direction starting at 10% to 25% and ending at 20% to 45%; then there follows a cranked part (4) starting at 20% to 35% and ending at 25% to 70% of the way along the radius, and thereafter the friction ring part (5) extends, adjoining the latter, from 25% to 70% of the way along the radius to 100% of the way along the radius.

4. The carbon-ceramic brake disc (1) according to claim 1, characterised in that its material is a ceramic reinforced with carbon fibres where of the matrix substantially comprises silicon carbide, silicon and carbon.

5. The carbon-ceramic brake disc (1) according to claim 1, characterised in that carbon fibres having an average length of more than 30 mm are used in the zone having the shape of a hub plate, comprising the regions of the face (3) and the cranked part (4).
